(19) United States
(12) Patent Application Publication
(10) Pub. No.: US 2009/0259572 A1
(43) Pub. Date: Oct. 15, 2009

(54) Collaborative alert distribution and management system

(76) Inventors: Mark Phillips Lay, Washington, DC (US); Catherine Hankins Veum, Falls Church, VA (US); Wen-Long Ronnie Shaw, Reston, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/385,399

(22) Filed: Apr. 7, 2009

Related U.S. Application Data
(60) Provisional application No. 61/071,036, filed on Apr. 9, 2008.
(60) Provisional application No. 61/136,727, filed on Sep. 29, 2008.

(51) Int. Cl. G06Q 99/00; G06Q 10/00; G06Q 50/00

(52) U.S. Cl. 705/28; 705/1

(57) ABSTRACT

A method for managing remediation of alerted products implemented using a computer having a processor and a display device is provided. The method comprises identifying an alert related to a product. The method also comprises facilitating handling of the alert by a user of the product. The method further comprises receiving data related to alert handling from the product user. The method further comprises analyzing the data related to alert handling with other data related to the alert. The method further comprises displaying the analyzed data on the display device. The method further comprises, based on the analyzed data, monitoring remediation efforts related to the alert.

### RELATED APPLICATIONS

This application claims the benefit of the filing date of U.S. Provisional Application No. 61/071,036 filed Apr. 9, 2008, and U.S. Provisional Application No. 61/136,727 filed Sep. 29, 2008, incorporated in their entirety by reference.

### FIELD OF THE INVENTION

The present invention relates generally to an enterprise application. More particularly, the present invention relates to supplier and customer collaboration services in an alert distribution and management system.

### BACKGROUND OF THE INVENTION

When a product supplier, such as a manufacturer, a distributor, or a reseller, determines that a product is defective or requires a customer intervention, the product supplier may issue an alert (e.g., a recall notice, field correction, repair instructions, etc.) to notify customer organizations and users to stop using the product, return the product, etc. Issuing an alert is costly to a product supplier because an alerted product may need to be replaced or fully refunded, but it often limits liability for a product supplier, protects public safety, and prevents further damage to the product supplier's corporate or trade image. To maximize these efforts, the product supplier should inform the affected parties as quickly as possible to limit potential safety implications.

A product alert may not be easy to learn about because, for example, a product supplier may not always widely publicize an alert. A product supplier may merely notify a government agency and/or only a few affected customer organizations. These types of alerts may not be publicized beyond the small subset of the customer communities. Further, a customer organization may have hundreds or thousands of products to search for alerts on and only limited resources for handling alerts.

### SUMMARY OF THE INVENTION

An alert distribution and management system with supplier and customer collaboration services using information technology may alleviate the supplier and customer collaboration problems in alert and returns management. One example of such a system may be the collaborative Risk and Safety Management Alert System (RASMAS) from Noblis. The alert distribution and management system with supplier and customer collaboration services provides new capabilities for product suppliers to collaborate with users and customer organizations related to remediation of alerted products and for the users and customer organizations to collaborate with one another in handling alerts.

In an alert distribution and management system consistent with embodiments of the present invention, alert-related remediation data may be analyzed and provided to product suppliers. Access to remediation data may enable product suppliers to evaluate alert and remediation processes, tailor future alerts, and monitor remediation efforts. Product suppliers may also manage reimbursement and repair of alerted products based on the remediation data. Using collaborative technologies and content management solutions provided by the system, product suppliers may manage remediation data, and distribute alert handling information, including multimedia, to specific users and customer organizations.

In addition, in an alert distribution and management system consistent with embodiments of the present invention, a user or customer organization may collaborate with other users or customer organizations in a community setting. In the community, a community member may be associated with a specific alert, and community members may be able to seek assistance or information from other community members who may be experts in handling a specific alert or in an alerted product. Community members having expertise may have a rating, ranking, or other indicator of the level of expertise. A member may be able to search and/or identify an expert based on different search criteria. The system may also promote collaboration among community members by forming an association to connect community members that perform similar roles in their respective customer organizations.

Consistent with embodiments of the invention, a method for managing remediation of alerted products implemented using a computer having a processor and a display device is provided. The method comprises identifying an alert related to a product. The method also comprises facilitating handling of the alert by a user of the product. The method further comprises receiving data related to alert handling from the product user. The method further comprises analyzing the data related to alert handling with other data related to the alert. The method further comprises displaying the analyzed data on the display device. The method further comprises, based on the analyzed data, monitoring remediation efforts related to the alert.

In another embodiment, a method for facilitating collaboration in alert handling among a plurality of users of a product using a computer having a processor is provided. The method comprises, for each of the plurality of product users, creating a profile specifying the user's role in handling alerts related to the product and a ranking of the user's expertise in alert handling. The method also comprises associating one product user with another product user based on the user profiles. The method further comprises providing a forum for the associated product users to share information related to alert handling.

In yet another embodiment, a system for managing remediation of alerted products is provided. The system comprises software components embodied on a computer-readable medium. The software components comprise an alert distribution and management component configured to identify an alert related to a product, facilitate handling of the alert by a user of the product, and receive data related to alert handling from the product user. The software components also comprise a collaboration component configured to analyze data related to alert handling with other data relating to the alert, and monitor remediation efforts related to the alert based on the analyzed data. The system also comprises a display device for displaying the analyzed data.

It is to be understood that both the foregoing general description and the following detailed description are exemplary and explanatory only, and should not be considered restrictive of the scope of the invention, as claimed. Further features and/or variations may be provided in addition to those set forth herein. For example, embodiments consistent with the present invention may be directed to various combinations and subcombinations of the features described in the following detailed description.

### BRIEF DESCRIPTION OF THE DRAWINGS

The accompanying drawings, which are incorporated in and constitute a part of this specification, illustrate various embodiments and aspects of the present invention. In the drawings:

FIG. 1 is a block diagram illustrating an exemplary alert distribution and management system with supplier and customer collaboration services consistent with embodiments of the present invention;

FIG. 2 is a flow diagram illustrating an exemplary alert collection and distribution process consistent with embodiments of the present invention;

FIG. 3 is a flow diagram illustrating an exemplary alert management and coordination assignment process consistent with embodiments of the present invention;

FIG. 4 is a block diagram illustrating an exemplary alert escalation process consistent with embodiments of the present invention.

FIGS. 5A-5D are screen displays of web pages generated and presented by an exemplary web application of an alert distribution and management system consistent with embodiments of the present invention;

FIGS. 6A-6G are screen displays of web pages generated and presented by an exemplary web application of supplier and customer collaboration services consistent with embodiments of the present invention;

FIG. 7 is a context diagram illustrating exemplary interactions between components in an exemplary alert distribution and management system with supplier and customer collaboration services consistent with embodiments of the present invention;

FIG. 8 is a screen display of an exemplary communication tool for customers in an alert distribution and management system with supplier and customer collaboration services consistent with embodiments of the present invention;

FIG. 9 is a screen display of an exemplary report of remediation data consistent with embodiments of the present invention;

FIGS. 10A-10C are screen displays of sample reports of remediation data consistent with embodiments of the present invention; and

FIG. 11 is a context diagram illustrating exemplary interactions among members of collaboration communities in an exemplary alert distribution and management system with supplier and customer collaboration services consistent with embodiments of the present invention.

### DESCRIPTION

Reference will now be made in detail to embodiments of the invention, examples of which are illustrated in the accompanying drawings. Implementations set forth in the following description do not represent all implementations consistent with the claimed invention. Instead, they are merely some examples consistent with certain aspects related to the invention. Wherever possible, the same reference numbers will be used throughout the drawings to refer to the same or like parts.

Once a user is notified of an alert, it can be difficult to learn about how to handle the alert. For example, an alert may be handled by removing, repairing, returning a defective product, changing a defective procedure, etc. Once a customer organization, such as a healthcare provider, has developed a response procedure or expertise in handling a particular alert, other customer organizations may benefit from sharing the expertise. However, the customers in need of assistance in handling alerts may not even know where to seek help resolving alerts. Even when information on handling alerts is available, it may be difficult to assess whether the information is reliable or from a trustworthy source. There may also be a type of alert that requires collaboration among many entities, for example, when a recall must involve removing all or a majority of recalled products from the market. Bringing affected customer organizations, especially healthcare providers, together to collectively handle alerts can be difficult.

In some instances, product suppliers may be the best source of expertise in handling alerts; however, product suppliers may often lack infrastructure to send the information to the affected customer organizations without alarming their unaffected customer base. Products are normally distributed to multiple users, directly or indirectly, and product suppliers, particularly manufacturers, often lack infrastructure or process to precisely learn the final destinations of their products. Product suppliers may benefit from learning how their products are remediated at various customer and/or user locations after recall notices have been sent out. The information collected from different users may help product suppliers to assess the damages resulting from alerts, and may be used to better manage the alerts and their businesses. The information may also be distributed to the customer organizations that are in need of help in handling the alerts. However, product suppliers also often lack mechanisms to collaborate with their customer organizations related to remediation of their alerted products, and to distribute information related to their products and remediation to specific customer organizations or users.

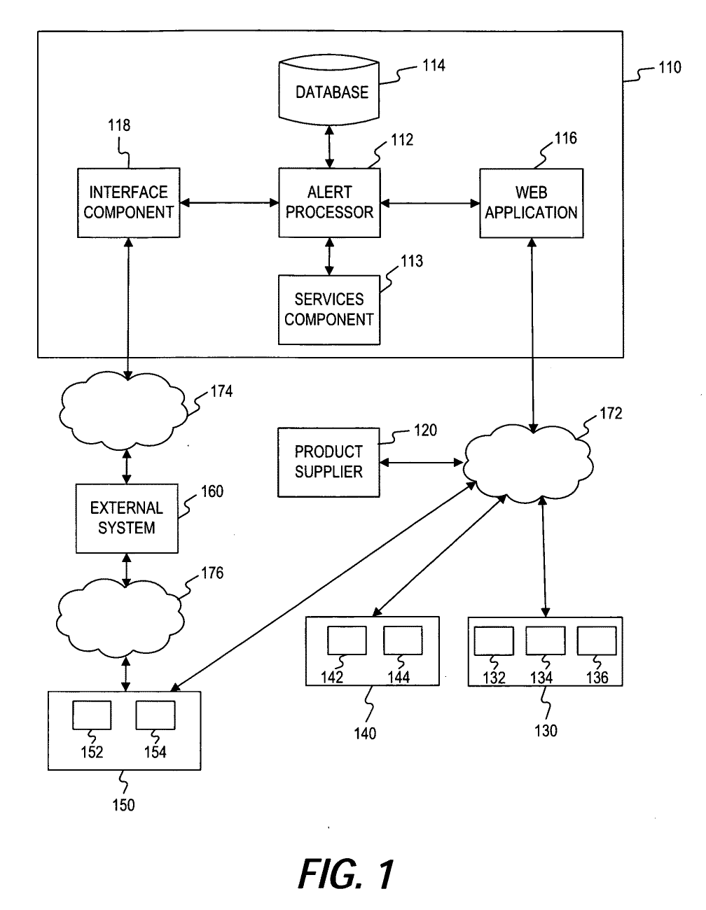

FIG. 1 illustrates an exemplary alert distribution and management system with supplier and customer collaboration services 110. As shown in FIG. 1, system 110 may include alert processor 112, services component 113, database 114, web application 116, and interface component 118. Alert processor 112, services component 113, database 114, web application 116, and interface component 118 may include any number of computers, devices, hardware, and/or mainframe located anywhere and distributed among multiple locations. Alert processor 112, services component 113, database 114, web application 116, and interface component 118 may also include operating systems, such as Microsoft Windows™, or any UNIX derived operating system, such as Linux™, Solaris™, and FreeBSD.

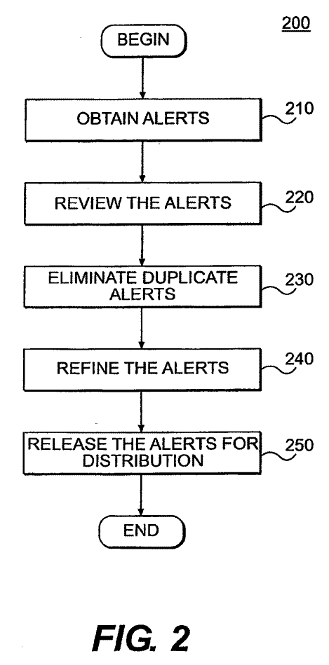

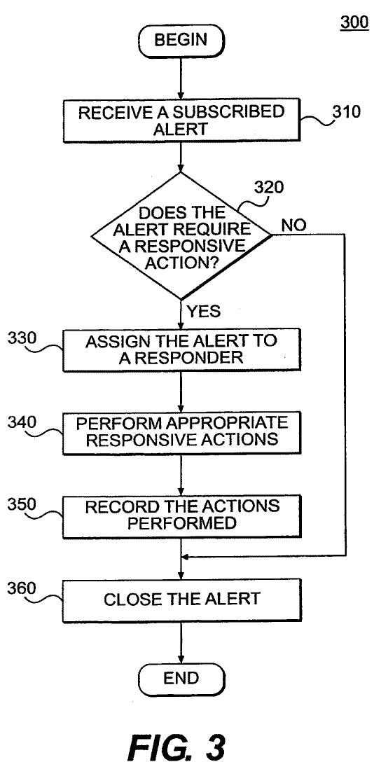

Alert processor 112 may perform alert distribution and management functionality, such as alert collection, distribution, management, and coordination assignment. For example, alert processor 112 may enable establishing accounts for new alert subscribing customer organizations and enable obtaining, enhancing, and distributing alerts to the customer organizations. To this end, alert processor 112 may perform alert collection and distribution process 200 and alert management and coordination assignment process 300, as described in more detail with respect to FIGS. 2 and 3, respectively.

Services component 113 may provide supplier and customer collaboration services, such as enabling collaboration among product supplier 120 and/or customer organizations 130, 140, and 150. For example, services component 113 may enable product supplier 120 to identify affected customer organizations and communicate information with the affected customer organizations. Services component 113 may also process remediation data collected from customer organizations 130, 140, and/or 150 for product supplier 120 to help product supplier 120 to evaluate its alert and remediation processes and efforts, plan its reimbursement and repair of alerted products, etc. For customer organizations 130, 140, and 150, for example, services component 113 may enable user 132 of customer organization 130 to identify an expert in handling an alert or a product. The expert may be, for example, related to customer organization 140 or 150, product supplier 120 or even within customer organization 130. Once an expert is identified, services component 113 may enable user 132 to communicate with the identified expert via various communication channels.

Database 114 may include a database management system (DBMS). The DBMS may store and retrieve data from, and manage database 114. To this end, the DBMS may provide services such as transactions and concurrency, indexing, security, and backup and replication. The DBMS may be based on, for example, a relational model, object database model, post-relational database model, hierarchical model, or flat model. In certain embodiments, a DBMS may be implemented as Oracle™ DBMS, IBM's DB2™, Microsoft SQL Server™, PostgresSQL, or MySQL®.

Database 114 may include a collection of data related to alert collection, distribution, management, and coordination assignment. For example, database 114 may store any data necessary for alert processor 112 to operate and provide its functionality. To this end, database 114 may include any data involved in alert collection and distribution process 200 and alert management and coordination assignment process 300, as described in more detail with respect to FIGS. 2 and 3, respectively. Database 114 may further include a collection of data related to management of returns, reimbursements, and replacements processes of alerted products.

Database 114 may also include a collection of data related to supplier and customer collaboration services. For example, database 114 may store collaborating member profiles. Member profiles may be collected from users 132, 134, 136, 142, 144, 152, and/or 154, and may include the name and address of the customer organizations that the users are associated with, the users' role in handling alerts within their customer organizations, etc. Member profiles may also include the users' contact information in case other users or product suppliers may desire to contact the users, data about specific products or alerts the users handle, etc. Database 114 may store product supplier profiles for one or more product suppliers 120. Product supplier profile data may include product supplier's contact information, product supplier's preference information, etc. By providing product supplier's preference information, product supplier 120 may specify, for example, what and how data is collected from customer organizations and presented to the product supplier, channels of communication with customer organizations, etc. In addition, database 114 may store comments and ratings for the comments, supplied by participating members, relating to specific alerts and alert handling.

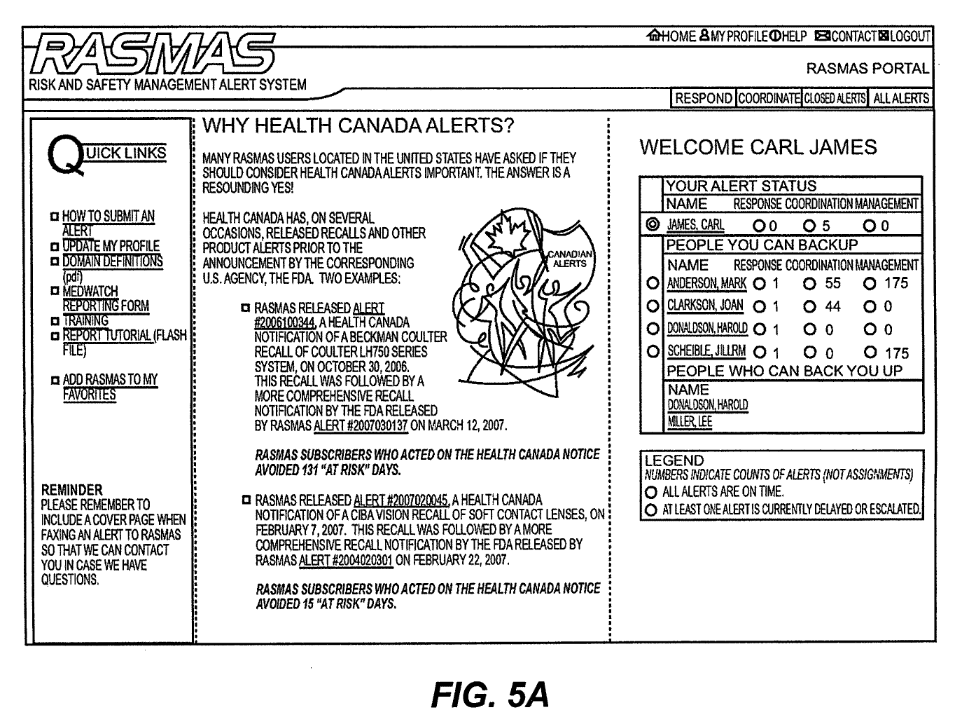

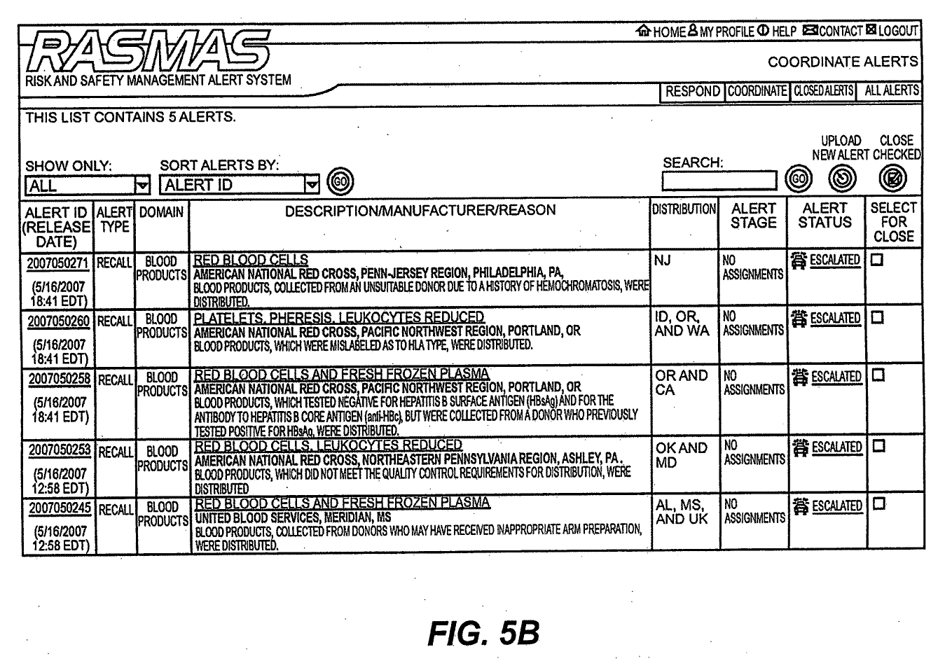

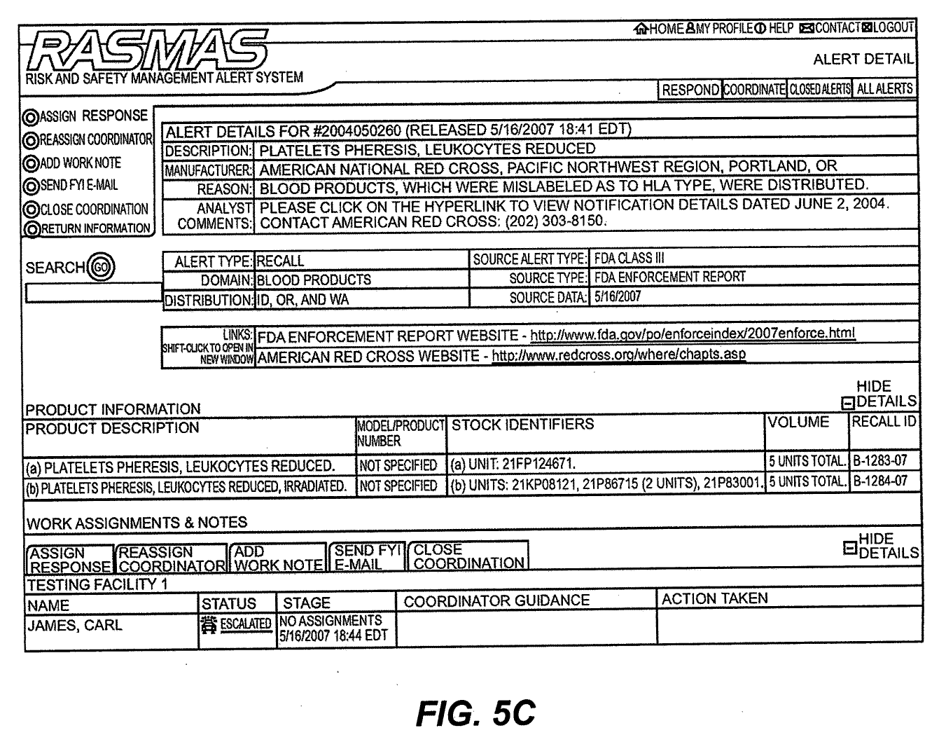

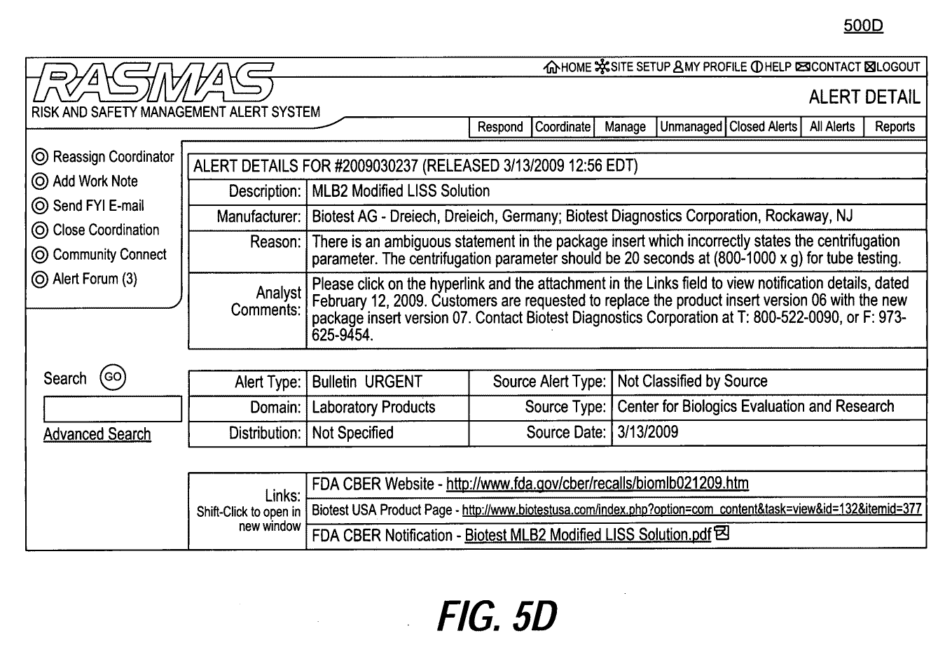

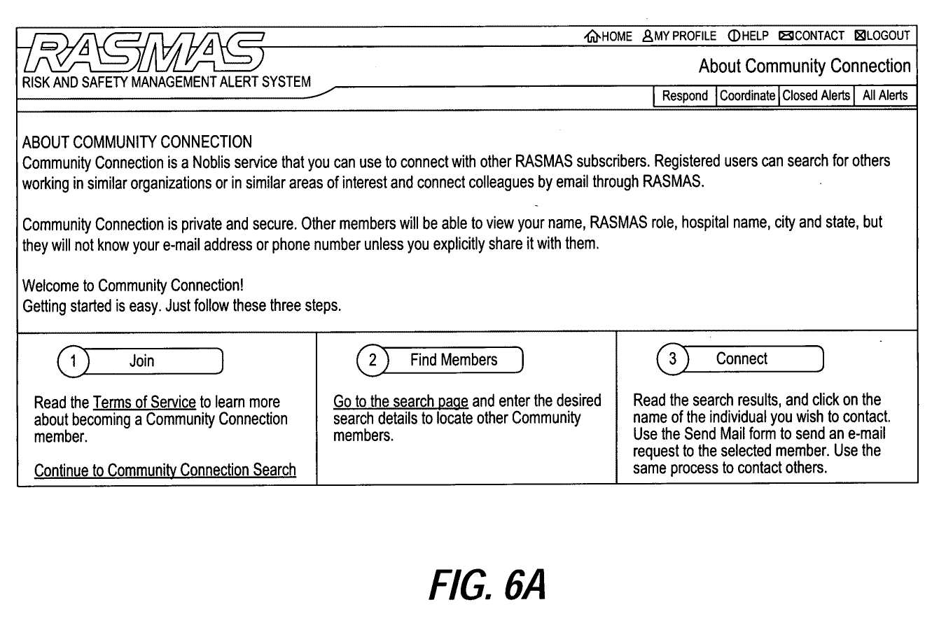

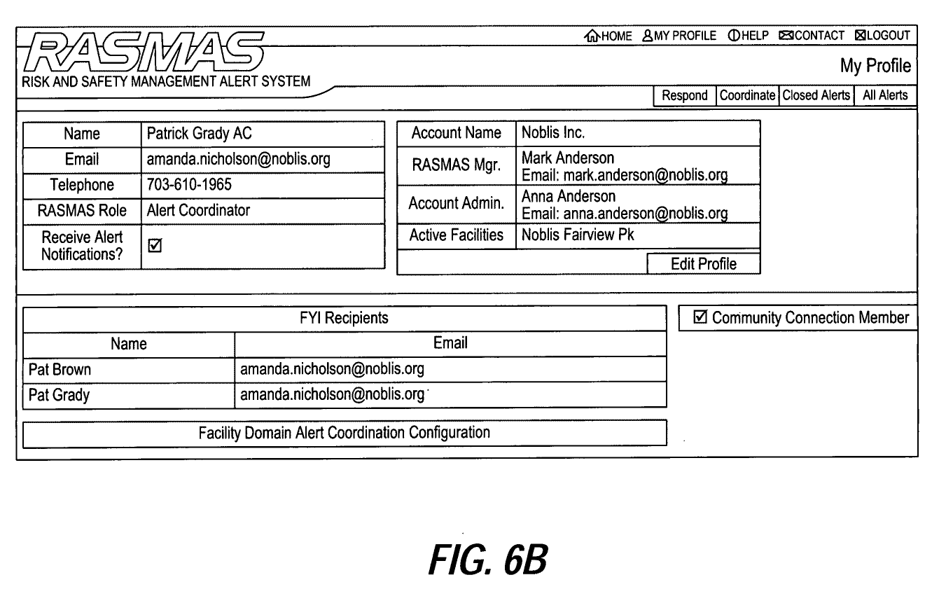

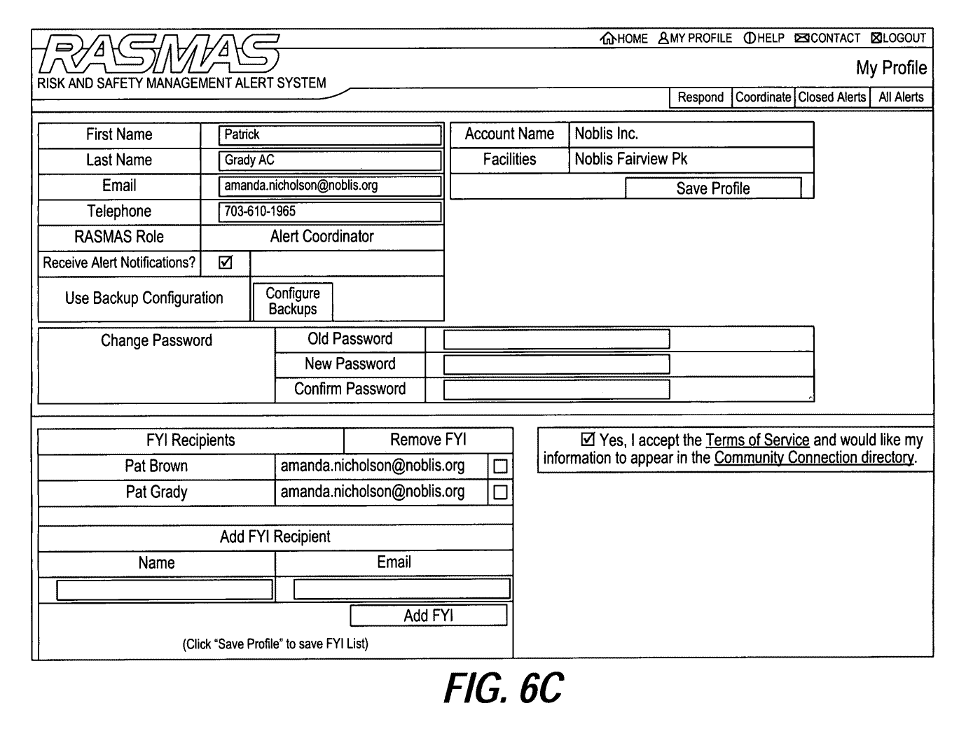

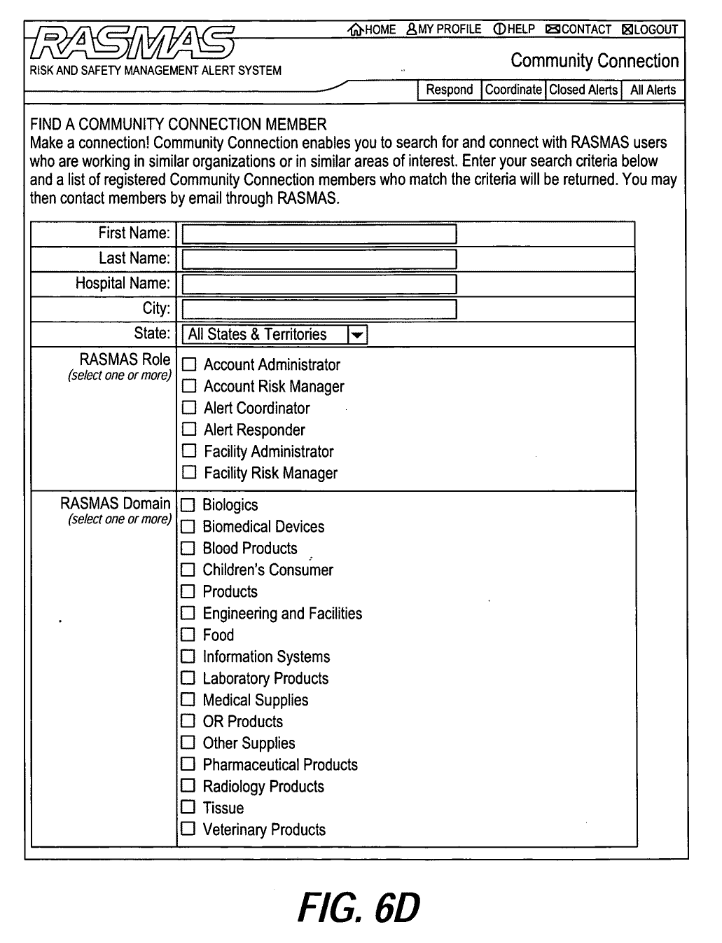

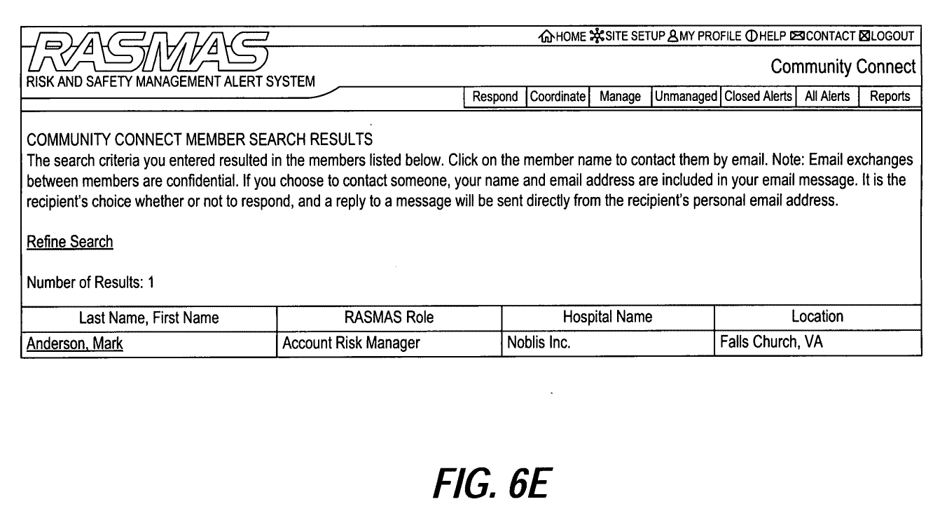

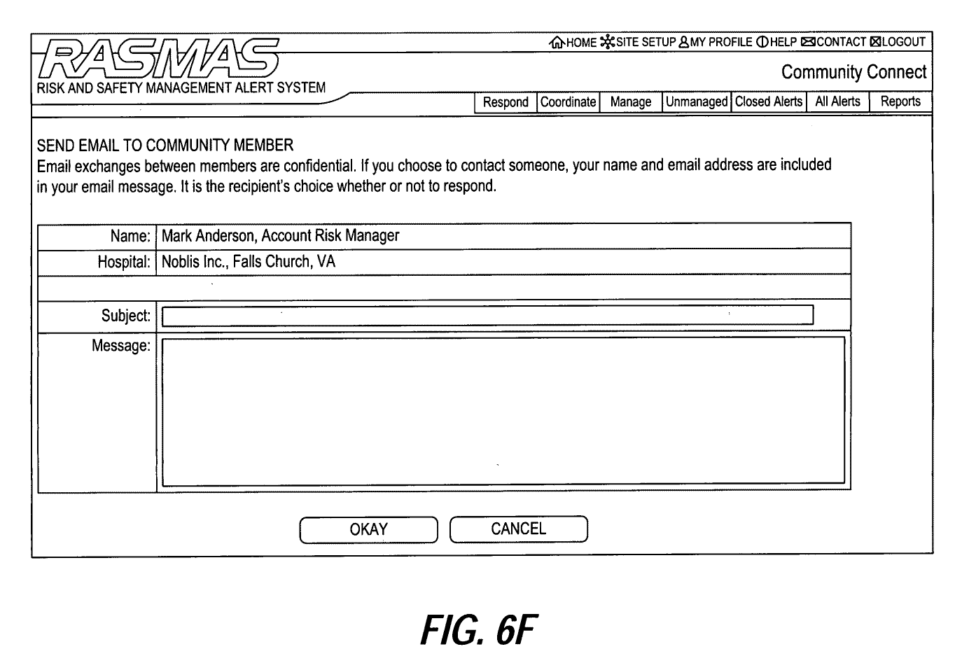

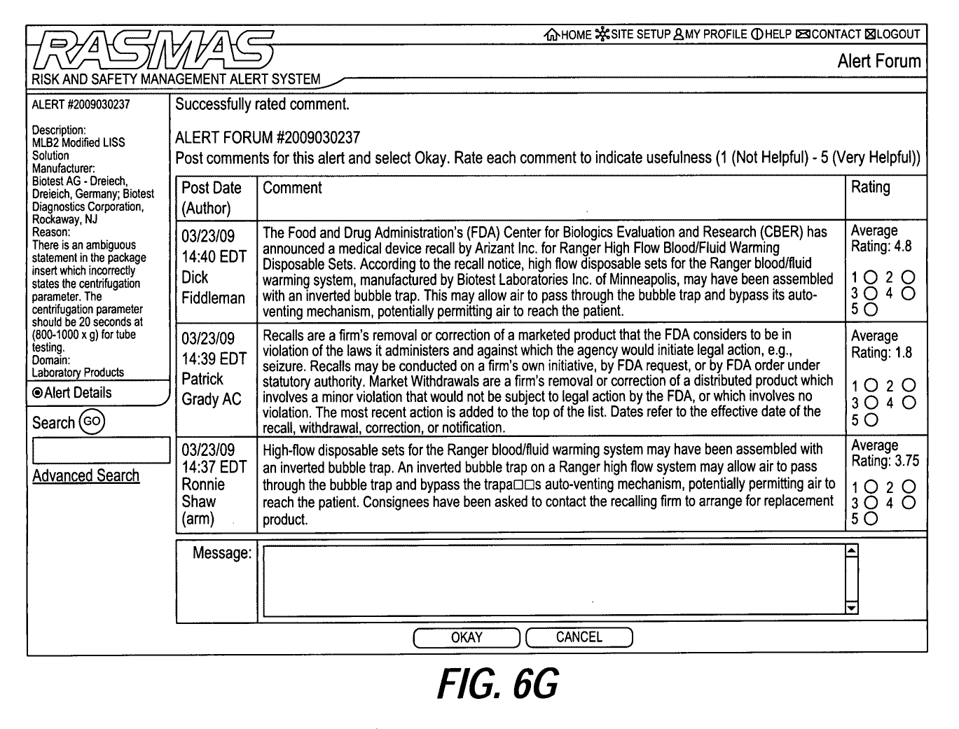

Through member profiles, the users may indicate whether they would be willing to be contacted and/or the users' contact information may be made available to other members and product suppliers. To this end, the users may indicate their desired level of participation as members of collaboration communities, such as the community connection, described further in detail with respect to FIGS. 5D and 6A-6F. The users may also opt out of supplier and/or customer collaboration services if they desire. In certain embodiments, the users may use a registration process to join a collaboration community. During the registration process, the users may be provided with terms and conditions, and asked to accept them before joining a collaboration community. The member profile data may be used to search for experts and determine an expert's level of expertise. In certain embodiments, a comments and ratings section including comments from members may be used in determining the members' level of expertise, reliability, etc. In other embodiments, experts' level of expertise may be determined using an algorithm based on various factors to ensure that the level of expertise may be fairly and objectively represented to the members of collaboration communities.

Web application 116 may include a web server. The web server may accept hypertext transfer protocol (HTTP/HTTPS) requests from users, such as product supplier 120 and users 132, 134, 136, 142, 144, 152, and 154 through network 172, and send HTTP/HTTPS responses back to the users with web pages, which may comprise hypertext markup language (HTML) or extensible markup language (XML) documents and any linked or embedded objects, such as images, videos, and other multimedia. For example, the web server may exchange XML-based messages with the users using Simple Object Access Protocol (SOAP) on top of HTTP/HTTPS. In certain embodiments, web application 116 may enable the members of collaboration communities, such as product suppliers 120 and users 132, 134, 136, 142, 144, 152, and 154, to communicate via chat rooms, live meetings, wiki collaboration, video training, etc. In other embodiments, web application 116 may rely on tools provided by a third party to enable the members of collaboration communities to communicate via chat rooms, live meetings, wiki collaboration, or video training. The web server may be implemented as Apache HTTP Server™, Internet Information Service (IIS)™, Sun Java System Web Server™, or IBM HTTP Server™ although any web server technologies may be used to provide the web server functionalities.

Web application 116 may include an application server that enables dynamic generation of web pages. For example, web application 116 may be based on Java Enterprise Edition (JEE) technologies, such as Java Server Page™ (JSP) and Java Servlet™, to enable dynamic generation of web pages, and a JEE application server, such as IBM's WebSphere™, BEA's WebLogic™, JBOSS™, and JRun™, may be employed as an application server to support the technologies. Web application 116 may alternatively employ Microsoft .NET Framework™, such as ASP.NET™ to enable dynamic generation of web pages.

Web application 116 may function as a user interface to system 110, and expose the functionalities of alert processor 112 and services component 113 to product supplier 120 and users 132, 134, 136, 142, 144, 152, and/or 154. To this end, web application 116 may present web pages to the users, receive requests originated from users, and repackage and/or relay the requests to alert processor 112 in the format understandable by alert processor 112. In addition, web application 116 may present web pages to the members of collaboration communities, such as product suppliers 120 and users 132, 134, 136, 142, 144, 152, and 154, receive requests originated from the members, and repackage and/or relay the request s to services component 113 in the format understandable by services component 113. After alert processor 112 or services component 113 finish processing the requests, web application 116 may receive results from the processing, generate web pages with the results, and present the web pages to the users. Web application 116 and exemplary web pages generated and presented by web application 116 are described in more detail with respect to FIGS. 5A-5D, 6A-6G, 7-9, and 10A-10C.

Customer organizations 130, 140, and 150 may subscribe to system 110 for alerts, and may access system 110 using web application 116, as shown in FIG. 1 Customer organizations 130, 140, and 150 may also manage returns, reimbursement, and replacement processes of alerted products. Customer organizations 130, 140, and 150 may be any organization that may receive, manage, and/or respond to alerts using system 110. For example, customer organizations 130, 140, and 150 may be hospitals or medical centers that receive product recall alerts in areas such as biomedical devices, blood products, children's consumer product such as toys, food, laboratory products, medical supplies, pharmaceutical products, radiology products, tissues and organs, engineering and facilities related products and devices, and healthcare related hardware and software. In certain embodiments, customer organizations 130, 140, and 150 may include a number of facilities, and each facility may receive alerts relevant to its functions only. For example, a facility with a pharmacy department may be interested in receiving product recall alerts in pharmaceutical products while a facility without a pharmacy department may not.

Customer organizations 130, 140, and 150 may employ any number of users that may manage and respond to alerts. In certain embodiments, customer organization 130 may employ users 132, 134, and 136, customer organization 140 may employ users 142 and 144, customer organization 150 may employ users 152 and 154, as shown in FIG. 1. In certain embodiments, users 132, 134, and 136 may manage and respond to alerts for all facilities within alert subscribing entity 130 while users 142 and 144 may manage and respond to alert for only one facility within alert subscribing entity 140. In certain embodiments, users 132, 134, and 136 may be charged with a single role in managing and responding to alerts while users 142 and 144 may be charged with multiple roles in managing and responding to alerts. For example, user 142 may be charged with a managing role (“manager”) that may require overseeing alert processing within alert subscribing entity 140. User 142 may also be charged with another role, such as an administrating role (“administrator”) that may require handling administrative tasks, such as entering data into system 110.

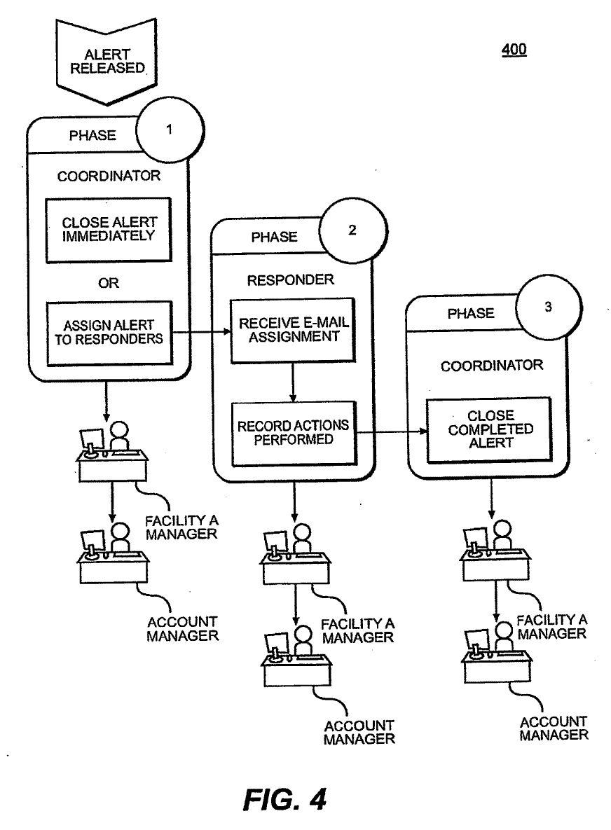

User 134 may be charged with a coordinating role (“coordinator”) that may require assigning alerts to a user charged with a responding role (“responder”). For example, in coordinating alerts, user 134 may assign a product recall alert to user 136, who may be a responder. The assignment may require user 136 to handle the alert by disposing of the recalled product. Failure to perform assigned roles may trigger an escalation process as described in greater detail with respect to FIG. 4. Actions that users 132, 134, 136, 142, 144, 152, and 154 may perform through web application 116 may be limited based on the assigned roles. In certain embodiments, however, any of users 132, 134, 136, 142, and 144 may access and perform any actions to manage returns, reimbursements, and replacements processes of the recalled products.

In certain embodiments where there may be multiple facilities within an alert subscribing entity, a role may be further divided into multiple managing roles to account for the hierarchy within the entity. For example, a managing role within an alert subscribing entity may include an account manager and multiple facilities managers. An account manager may manage all alerts within the alert subscribing entity, and may be responsible for receiving a daily summary of alert activities and workflow within the entity. Each facility within the entity may have a facility manager. A facility manager may manage all alerts within one facility, and may be responsible for receiving a daily summary of alert activities and workflow within the facility only.

System 110 may interface with one or more external system 160 using interface component 118. In certain embodiments, external system 160 may run outside the firewall of system 110, and connect to system 110 using one or more ports that are opened by interface component 118 for external system 160. External system 160 may be any system that interacts with system 110, for example, to request system 110 to perform a process or obtain data related to alert collection, distribution, management, coordination assignment, and returns, reimbursements, and replacements of alerted products. In certain embodiments, external system 160 may receive a request from system 110. In response to the request, external system 160 may perform a process and/or send data to system 110. Data from external system 160,,which may otherwise be entered manually into system 110, may be used in generating web pages of web application 116 although the data may be used for any other purposes. In certain embodiments, external system 160 may be an enterprise resource planning (ERP) system, procurement system, accounting system, inventory system, materials management system, supply chain management system, and/or external database system.

Rather than using web application 116, customer organization 150 may alternatively receive, manage, and respond to subscribed alerts using external system 160. In certain embodiments, external system 160 may be any system that provides alert collection, distribution, management, and/or coordination assignment functionalities and/or alerted product returns, reimbursement, and replacement management functionalities using alert processor 112 of system 110 for providing functionalities. For example, external system 160 may retrieve alert data from system 110, and present the data to users 152 and 154. To this end, external system 160 may include its own user interface to present the retrieved data to users 152 and 154 and to interact with the users. Through its own user interface, external system 160 may customize the obtained alerts for its alert subscribing customer organizations, such as customer organization 150. In certain embodiments, external system 160 may be developed or customized to provide alert management and coordination assignment services for a specific industry or a specific segment of an industry that may not conveniently use web application 116. By being external to system 110, external system 160 may receive user actions before the actions are received by system 110. In certain embodiments, external system 160 may modify and/or filter out the user actions in accordance with its own rules that may be more restrictive than ones implemented in system 110. The user interface of external system 160 may be implemented as a web-based application. To this end, external system 160 may include web servers, application servers, and/or databases.

As shown in FIG. 1, in some embodiments, interface component 118 may act as a gateway between external system 160 and system 110. To support external systems developed under multiple technologies, interface component 118 may use a Service Oriented Architecture (SOA), and may be implemented using Common Object Request Broker Architecture (CORBA), Web Service, Simple Object Access Protocol (SOAP), Remote Procedure Call (RPC), Distributed Component Object Model (DCOM), or Windows Communication Foundation (WCF).

Networks 172, 174, and 176 may be any type of communication mechanism and may include, alone or in any suitable combination, a telephony-based network, a local area network (LAN), a wide area network (WAN), a dedicated intranet, wireless LAN, the Internet, an Intranet, a wireless network, a bus, or any other communication mechanisms. Further, any suitable combination of wired and/or wireless components and systems may provide networks 172, 174, and 176. Moreover, networks 172, 174, and 176 may be embodied using bidirectional, unidirectional, or dedicated communication links. In certain embodiments, networks 172, 174, and 176 may be the same.

As shown in FIG. 1, services component 113 may seamlessly interact with alert processor 112. In certain embodiments, they may be combined. Services component 113 may interact with alert processor 112 to provide supplier and customer collaboration services. For example, services component 113 may use alert data collected from customer organizations during alert collection, distribution, management, and coordination assignment processes. With access to the data, services component 113 may identify customer organizations that may have been affected by a specific alert, aggregate the data collected from each of the affected customer organizations, etc. In addition, service component 113, using the data, may identify participating members who may have specific relationships with certain alerts. This may help service component 113 to return more focused and relevant search results when one participating member searches for information.

In certain embodiments, the interaction between alert processor 112 and services component 113 may not be noticeable to members of collaboration communities, such as product supplier 120 and users 132, 134, 136, 142, 144, 152, and 154. For example, while viewing an alert detail page, such as the web page depicted in FIG. 5D, the member may click a hypertext link. The link may direct the member to a collaboration services web page, such as the alert forum page described in FIG. 6G. After accessing collaboration services, the member may be directed back to the alert detail page. In certain embodiments, a separate web application may provide collaboration services and the member may receive a notice when the member is being directed to a different web application. The notice may help the member to remember that his action, such as comments supplied by the member, may be seen and read by users from other customer organizations, suppliers, etc.

In addition, access restrictions may be implemented between web pages generated in connection with alert processor 112 and collaboration services web pages generated in connection with services component 113. For example, a non-participating user, such as a user who has opted out of the supplier and customer collaboration services and/or has not joined collaboration communities, may not have access to collaboration services. To this end, a link to collaboration services web pages may not be offered to the non-participating user on the web pages of alert processor 112. In other embodiments, the non-participating user may receive an offer to join collaboration communities when the non-participating user selects a link to collaboration services web pages.

In certain embodiments, product suppliers, such as product supplier 120, may have access only to web pages generated in connection with services component 113. To this end, services component 113 may provide product supplier focused functionalities. For example, by using web pages generated in connection with services component 113, product supplier 120 may view a list of alerts that product supplier 120 has issued. Product supplier 120 may select a specific alert from the list and view more detailed information about the specific alert. The product supplier functionalities of services component 113 may not be accessible by members from customer organizations.

FIG. 2 illustrates an exemplary alert collection and distribution process 200. System 110 may obtain alerts, e.g., from multiple sources (step 210). For example, system 110 may obtain alerts from websites or other systems. System 110 may monitor the websites and other systems, and obtain alerts automatically when triggering events occur. System 110 may also receive alerts from manufacturer recall notices. System 110 may further receive alerts from its alert subscribing customer organizations, such as customer organizations 130, 140, and 150. Once obtained, the alerts may be reviewed, for example, by a quality control staff, or automatic review process (step 220). Upon reviewing the alerts, the reviewer may delete duplicate alerts (step 230). System 110 may edit remaining alerts to enhance the quality of alert content (step 240). For example, system 110 may add additional information to clarify alerts. The alerts may then be put into a standard format with a consistent set of data elements, and released for distribution to alert subscribing entities (step 250). In certain embodiments, the released alerts may be filtered so that only desired alerts may reach each facility within the alert subscribing customer organizations.

FIG. 3 illustrates an exemplary alert management and coordination assignment process 300. Each facility within alert subscribing entities, such as customer organizations 130, 140, and 150 may receive a subscribed alert (step 310). A coordinator, such as user 134, may review the subscribed alert to determine whether it requires a responsive action (step 320). Upon review, if user 134 determines that the alert requires no further action (step 320 “No”), user 134 may close the alert (step 360). If user 134 determines that the alert requires a responsive action (step 320 “Yes”), user 134 may assign the alert to a responder, such as user 136 (step 330). User 136 may perform a task or tasks in response to the alert (step 340). For example, user 136 may dispose of any recalled products in response to a product recall alert. After user 136 completes the task(s), user 136 may record actions performed in system 110, e.g., by using web application 116 (step 350). User 134 may then close the alert (step 360). In certain embodiments, users may be notified by an e-mail at the completion of the step. For example, when a responder completes an action in response to an alert, a coordinator may receive an automatic e-mail notification via system 110.

FIG. 4 depicts an exemplary alert escalation process 400. As shown in FIG. 4, process 400 may comprise three phases. Phase 1 depicts a stage in alert management and coordination process 300 where an alert has been released to an alert subscribing entity. A coordinator who is assigned to the alert may have a specified number of days to take an action, for example by closing the alert or assigning the alert to a responder to handle the alert. In cases where the coordinator fails to take any action within the specified number of days, the alert may be escalated to a facility manager as shown in FIG. 4. The facility manager may have a specified number of days to take an action, for example, by reminding the coordinator of the alert or reassigning the alert to a different coordinator. If the facility manager fails to take an appropriate action within the specified number of days, the alert may be escalated to an account manager.

Phase 2 depicts a stage in alert management and coordination process 300 where the alert has been assigned to a responder. The responder has a specified number of days to take an action to handle the alert, for example, by disposing of alerted products and/or returning alerted products to a manufacturer, and record the actions performed. In cases where the responder fails to take an appropriate action within the specified number of days, the alert may be escalated to a facility manager as shown in FIG. 4. Similar to Phase 1, the facility manager may have a specified number of days to take an action. If the facility manager fails to take an appropriate action within the specified number of days, the alert may be escalated to an account manager.

Phase 3 depicts a stage in alert management and coordination process 300 where the alert has been handled by a responder and the action performed has been recorded. The coordinator who is assigned to the alert has a specified number of days to close the alert. In cases where the coordinator fails to close the alert within the specified number of days, the alert may be escalated to a facility manager as shown in FIG. 4. The facility manager may have a specified number of days to take an action. Failure to taken an action by the facility manager may escalate the alert to an account manager.

FIGS. 5A-5D depict screen displays of exemplary web pages generated and presented by exemplary web application 116 of system 110. A user may log into web application 116 and see a welcome page, as shown in FIG. 5A. The left column of the welcome page may display quick links, and the center column of the page may display alert and recall related news or information. The right column of the page may display a summary and status of currently open alerts that may require the user's action. For example, for the user “Carl Jones,” an alert status shows that the user is a coordinator for five (5) alerts, with zero (0) alert as a responder or manager. As shown in the legend, colors or other indicators may show delayed or escalated alerts.

On the list page shown in FIG. 5B, the user may see a list of the alerts that may require the user's action. The screen may include alert ID with alert release date, alert type, domain, description and manufacturer of the product being alerted, reason for alert, distribution of the alert, alert stage, and alert status. The user may take an action, such as closing the alert, on this screen.

On the detail page shown in FIG. 5C, the user may see more detailed information about one of the alerts listed on the list screen shown in FIG. 5B. The detail information may include, in addition to the information shown in the list screen, comments by an alert analyst, source alert type, source type, detail product information, and work assignments information. The detail page may include links to perform several actions, for example, in the left column as shown in FIG. 5C. In certain embodiments, the links may include “ASSIGN RESPONSE,” “REASSIGN COORDINATOR,” “ADD WORK NOTE,” “SEND FYI E-MAIL,” “CLOSE COORDINATION,” and “RETURN INFORMATION” links. The “RETURN INFORMATION” link may direct the user to web pages that may facilitate the user to manage returns, reimbursement, and replacement processes of alerted products. Exemplary returns, reimbursements, and replacements management and processes of alerted products are illustrated in commonly owned U.S. patent application Ser. No. 12/071,101.

On the detail page 500D shown in FIG. 5D, the user may see detailed information about another alert; for example, Alert No. 2009030237. Detail page 500D may include links that may be different from the links included on the detail page of FIG. 5C. For example, detail page 500D may include “Community Connect” and/or “Alert Forum” links. The “Community Connect” and “Alert Forum” links enable the user to access collaboration services, e.g., web page generated in connection with services component 113. Although detail page 500D shows hypertext links used to provide collaboration services to the user, other mechanisms, such as meta redirect, script language, and network programming, may also be used.

FIGS. 6A-6G are screen displays of web pages generated and presented by a web application of exemplary supplier and customer collaboration services consistent with embodiments of the present invention. When the user clicks on the “Community Connect” link on detail page 500D, the user may be directed to an About Community Connection page, as shown in FIG. 6A. The About Community Connection page may present the user with a description of services that the community connection may provide. In certain embodiments, the About Community Connection page may act as a portal or home page for collaboration services. To this end, the About Community Connection page may present the user with a list of actions that the user may take. For example, the user may select “JOIN,” as shown in FIG. 6A, to become a member of the community connection. When this option is chosen, the user may be asked to go through a registration process, which may ask the user to read terms and conditions of the services and accept them. A confirmation e-mail may be sent to the user after the registration. In addition, a notification of new member registration may be sent to a community manager. A community manager may monitor and facilitate activities taking place in the community connection to enhance member collaboration experience. In other embodiments, the user of system 110 may be automatically registered to the community connection services by virtue of being a user of system 110. The user may then be given an opportunity to opt out of the services.

From the About Community Connection page of FIG. 6A, the user may choose to view and edit his profile by clicking “MY PROFILE” on the top right side of the page. Clicking “MY PROFILE” may direct the user to a My Profile page, as shown in FIG. 6B. The user may choose to edit portions of the profile by clicking “Edit Profile” button shown in FIG. 6B, which may direct the user to an edit my profile page as shown in FIG. 6C. In certain embodiments, alert processor 112 and services component 113 may share same profile data for the same user so that the user may not need to manage his profile in multiple locations. To this end, the profile may be inclusive to support both alert processor 112 and services component 113. In other embodiments, services component 113 may have its own profile data that may be specific to collaboration services.

As shown in FIGS. 6B and 6C, the profile may include the user's name, contact information, role in alert handling and management, preference to receive an alert notification, list of e-mails of FYI recipients, etc. In addition, the profile may include information about a customer organization associated with the user. In certain embodiments, the user may be able to opt-in and opt-out of the community connection services using a check box, as shown in FIG. 6C.

Although it is not shown in FIGS. 6B and 6C, the profile, in certain embodiments, may include further information about the user and the user's preferences in using collaboration services. For example, the information about the user may include data related to the user's level of experience, responsibility, or expertise in handling alerts and/or in alerted products. The user's preferences may include the user's preferred communication channels, time for such communication, etc. In addition, the user may restrict, using the profile, his availability and/or the accessibility of his comments or postings. For example, the user may desire to block certain members from contacting the user. Likewise, the user may desire to block certain members from viewing the user's comments or postings. The restrictions may be accomplished by setting his preferences in the profile. In certain instances, the user may desire to filter out certain members when the user searches for an expert. Likewise, the user may desire to filter out comments and postings supplied by certain members. In certain embodiments, the restriction and filtering may be achieved at the customer organization level.

Once the user becomes a member of the community, the user may choose option #2, “Find Members,” from the list of options on the About Community Connection page of FIG. 6A. This option may direct the searching member to a Find Member page as shown in FIG. 6D. Using the Find Member page of FIG. 6D, the searching member may provide search criteria, and get search results back with a list of members that match the search criteria. For example, as shown in FIG. 6D, the searching member may search by the first or last name of a community connection member, the name and address of customer organization, such as hospital name and city and state where the hospital is located, alert handling role, product domain, etc. The search results may be provided to the searching member, for example, on a search results page as shown in FIG. 6E. The search results page of FIG. 6E shows one member matching the search criteria. The name of the matching member may be presented as a hypertext link so that the searching member may click on the link if the searching member desires to contact the matching member.

The searching member may alternatively choose option #3, “Connect” from the list of options on the About Community Connection page of FIG. 6A to contact the matching member. The searching member may be presented with a send e-mail page as shown in FIG. 6F. In certain embodiments, the contact information of the matching member may be hidden from the searching member so that the searching member may not be able to communicate with the matching member outside the communication channels provided by the community connection. For example, as shown in FIG. 6F, the searching member may type in, without knowing the matching member's contact information, the subject and message of the e-mail, and click “OKAY” button to send the e-mail to the matching member. Limiting communications to the community connection provided channels may protect privacy of the members. In certain embodiments, product supplier 120 may also become a member of community connection. Product supplier 120 may search for members and contact matching members using the community connection services. In addition, product supplier 120 may be identified by search and contacted by other members of community connection.

When the user of system 110 clicks on the “Alert Forum” link on detail page 500D, the user may be directed to an alert forum page, as shown in FIG. 6G. The Alert Forum may provide a forum for the users to discuss and share information, e.g., related to a specific alert. For example, as shown on the alert forum page of FIG. 6G, the users may discuss and share information by posting comments related to Alert No. 2009030237 on a message board. The users may rate the comments posted by other users, and the average rating may be calculated and presented as shown in FIG. 6G. In certain embodiments, the alert forum page of FIG. 6G may be accessible to only community connection members. In other embodiments, the alert forum page of FIG. 6G may be accessible to all users of system 110 who have access to detail page 500D. In certain embodiments, certain users may have read permission without write permission. For example, certain users may be able to read the comments posted by other users, but may not be allowed to post their own comments. Although a message board is shown in FIG. 6G, other mechanisms, such as wiki collaboration and chat rooms, may be used to support the alert forum features.

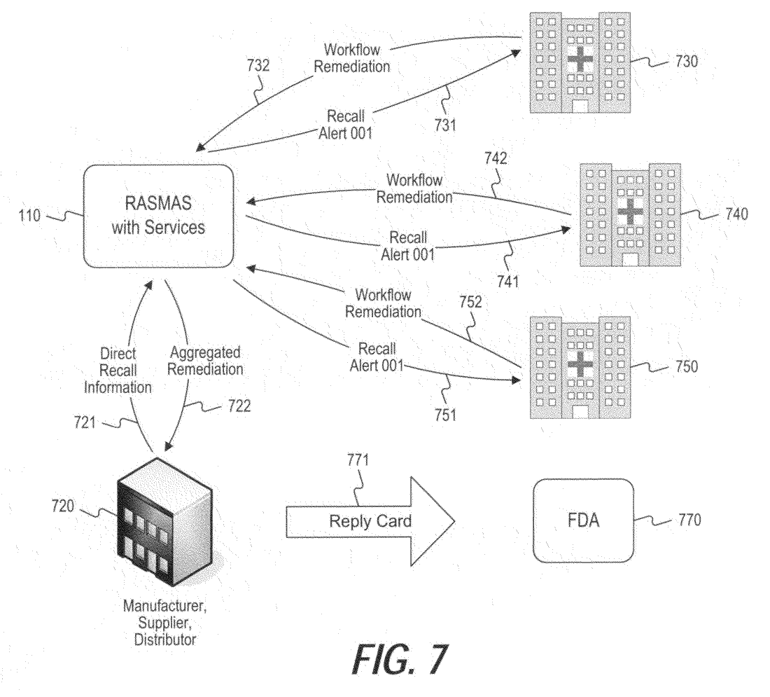

FIG. 7 is a context diagram illustrating exemplary interactions among components in an exemplary alert distribution and management system with supplier and customer collaboration services consistent with embodiments of the present invention. FIG. 7 depicts communications with collaborative alert system 110. As indicated by arrow 712, system 110 may receive direct recall information from a product supplier 720, such as a manufacturer, supplier, and/or distributor. Receiving recall information from product supplier 720 may be, for example, part of step 210 of alert collection and distribution process 200, which is described in more detail with respect to FIG. 2. System 110 may process the received recall information, e.g., according to steps 220-240 of alert collection and distribution process 200. As indicated by arrows 731, 741, and 742, system 110 may distribute the processed information as recall alerts to customer organizations 730, 740, and 750. Distributing recall alerts to customer organizations 730, 740, and 750 may be, for example, part of step 250 of alert collection and distribution process 200.

Customer organizations 730, 740, and 750 may manage received recall alerts, for example, according to alert management and coordination assignment process 300, described in more detail with respect to FIG. 3. Customer organizations 730, 740, and 750 may record the actions taken to handle the recall alerts according to step 350 of alert management and coordination assignment process 300. As indicated by arrows 732, 742, and 752, recorded actions and other remediation data, may be provided to system 710.

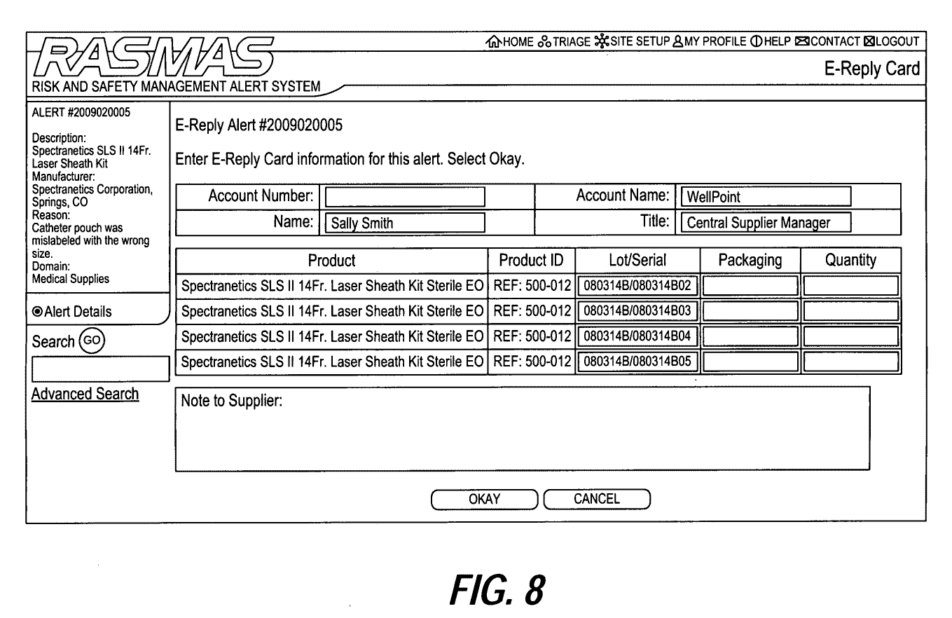

In addition, each of customer organizations 730, 740, and 750 communicate with system 110, for example using a reply form, such as an E-Reply Form shown in FIG. 8. Some of the data on the reply form of FIG. 8 may be pre-populated by system 110, as shown in FIG. 8. For example, name, product ID, and Lot/Serial information of alerted product, account name, and name and title of the user may be pre-populated as shown in FIG. 8. Customer organizations 730, 740, and 750 may only need to provide fields such as an account number, packaging, and quantity information to complete the form. In addition, customer organizations 730, 740, and 750 may optionally provide notes to product supplier 720. Packaging and quantity may represent how products are packaged and how many products are located at the customer organizations.

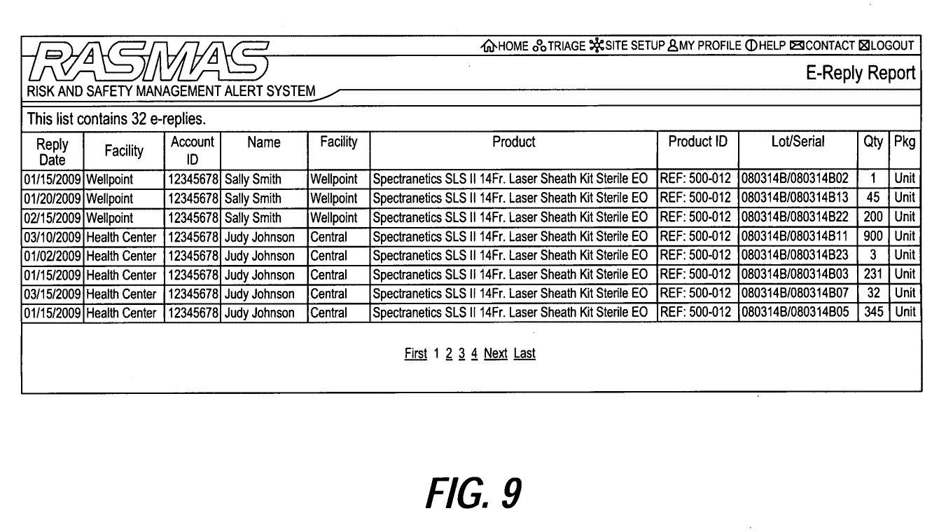

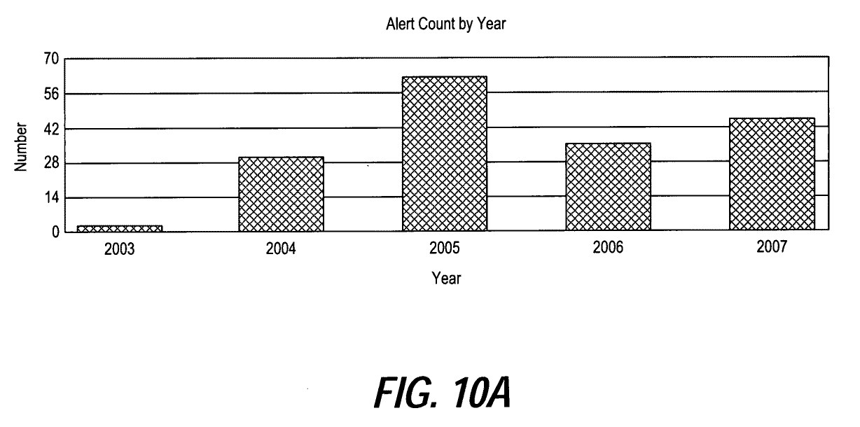

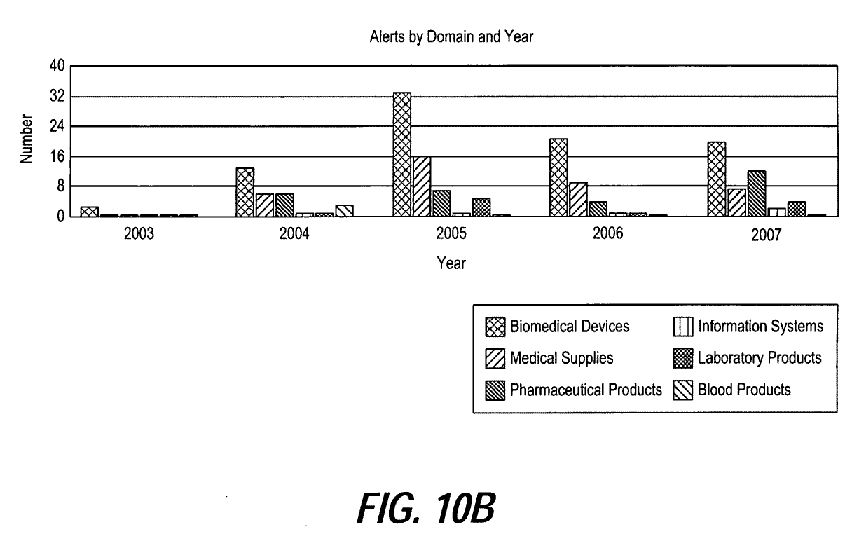

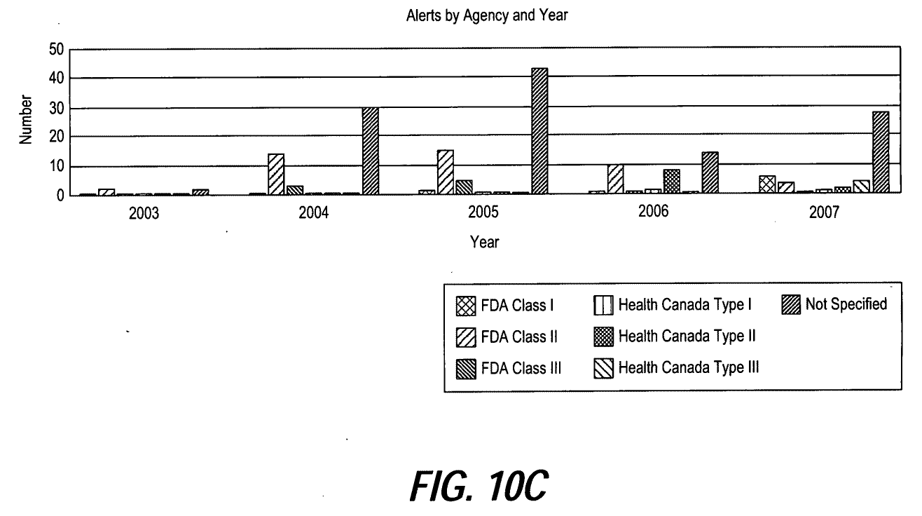

System 110 may process the remediation data including data provided by customer organizations 730, 740, and 750 through reply forms, such as the E-Reply Form of FIG. 8. System 110 may present aggregated remediation data to product supplier 720, as indicated by arrow 722 in FIG. 7. In certain embodiments, aggregated data from customer organizations 730, 740, and 750 may be presented to product supplier 720 on a reply report, such as the exemplars E-Reply Report shown in FIG. 9. For example, the E-Reply Report of FIG. 9 shows a list containing data from several customer organizations, such as Wellpoint and Health Center. In addition, product supplier 720 may generate various types of historical report based on aggregated remediation data. Several examples of reports that may be generated by product supplier 720 may include alerts count, alerts by domain, and alerts by agency, as shown in FIGS. 10A-10C. The reports may be generated for different time periods, customer organizations, products, etc. For example, the historical reports of FIGS. 10A-10C show yearly data. The generated reports and remediation data may be used to prepare a report or reply card for a government or regulatory agency 770, such as Food and Drug Administration (FDA). Reports could also be made to other entities, such as parent companies of customer organizations, insurance carriers, public, etc.

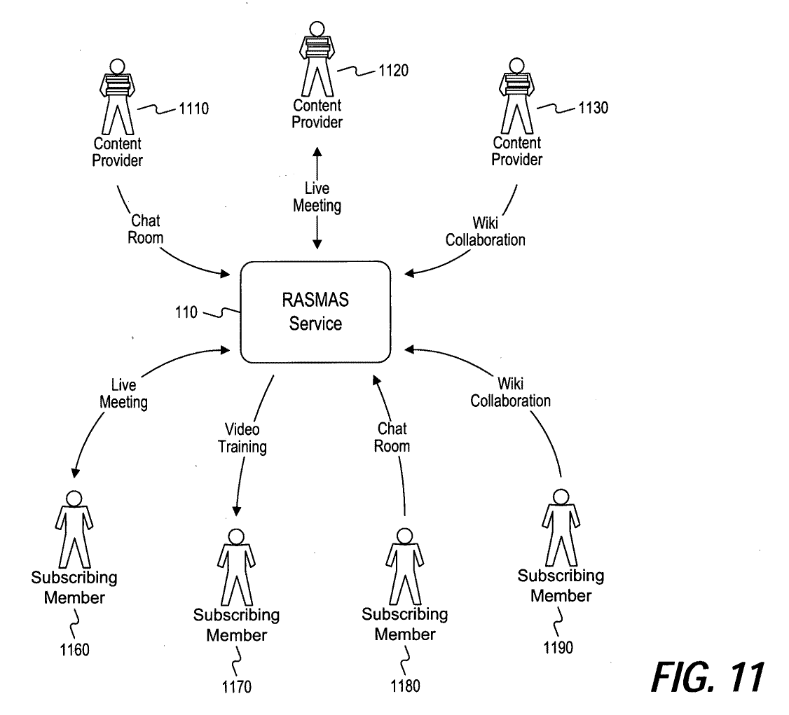

FIG. 11 is a context diagram illustrating exemplary interactions among members of collaboration communities in an exemplary alert distribution and management system with supplier and customer collaboration services consistent with embodiments of the present invention. Members of collaboration communities may be, at times, content providers, such as content providers 1110, 1120, and 1130, and subscribing members, such as subscribing members 1160, 1170, 1180, and 1190. Content providers 1110, 1120, and 1130 may include members from product supplier 720, industry experts, members from customer organizations 730, 740, or 750 who are experts in handling specific alerts, etc. Subscribing members may include members from product suppliers and/or customer organizations who seek content, such as help responding to an alert, access to repair protocols, etc. As shown in FIG. 11, content providers 1110, 1120, and 1130 and subscriber members 1160, 1170, 1180, and 1190 may collaborate using a variety of communication channels provided by system 110. The communication channels may include any communication channels that may be supported by network 172. For example, the communication channels may include chat rooms, live meetings, wiki collaboration, video training, etc.

One of ordinary skill in the art will recognize that while some of the drawings illustrate steps performed in a particular order, the order in which the steps are carried out is irrelevant. Systems consistent with the invention may carry out the steps in any order or in some cases combine or omit one or more steps without departing from the scope of the present disclosure.

Other embodiments of the invention will be apparent to those skilled in the art from consideration of the specification and practice of the invention disclosed herein. For example, the collaboration environment of FIG. 11 may include more or fewer content providers and/or subscribing members. It is intended that the specification and examples be considered as exemplary only, with a true scope and spirit of the invention being indicated by the following claims.

What is claimed is:

1. A method for managing remediation of alerted products implemented using a computer having a processor and a display device, the method comprising:
identifying an alert related to a product;
facilitating handling of the alert by a user of the product;
receiving data related to alert handling from the product user;
analyzing the data related to alert handling with other data related to the alert;
displaying the analyzed data on the display device; and
based on the analyzed data, monitoring remediation efforts related to the alert.

2. The method of claim 1, wherein facilitating handling of the alert further comprises facilitating collaboration in alert handling among a plurality of users of the product.

3. The method of claim 2, wherein facilitating collaboration in alert handling further comprises:
identifying a target user among the plurality of users of the product; and
providing a communication channel between the target user and users of the product.

4. The method of claim 3, wherein identifying a target user further comprises identifying a product user based on search criteria.

5. The method of claim 3, wherein identifying a target user among the plurality of product users further comprises identifying a target user based on feedback from the plurality of product users.

6. The method of claim 3, wherein the communication channel comprises one of e-mail, a chat room, a live meeting, wiki collaboration, and video training.

7. The method of claim 1, further comprising:
identifying a user of the product affected by the alert; and
distributing information related to the alert to the product user.

8. The method of claim 7, wherein distributing information related to the alert further comprises:
receiving content related to the alert from a product supplier; and
distributing the content to the product user.

9. The method of claim 7, wherein distributing information related to the alert further comprises distributing information related to the alert via at least one of chat room, live meeting, video training, and wiki collaboration.

10. The method of claim 1, further comprising:
receiving a request from a user of the product for information on handling the alert; and
providing the product user with information on handling the alert based on the analyzed data.

11. The method of claim 10, wherein the information on handling the alert data includes at least one of: information on removing the alerted product, information on repairing the alerted product, information on returning the alerted product, and information on proper usage of the alerted product.

12. The method of claim 1, wherein displaying the analyzed data further comprises generating a report based on the analyzed data.

13. The method of claim 1, wherein monitoring remediation efforts further comprises planning reimbursement or repair of alerted products based on the analyzed data.

14. A method for facilitating collaboration in alert handling among a plurality of users of a product using a computer having a processor, the method comprising:
for each of the plurality of product users, creating a profile specifying the user's role in handling alerts related to the product and a ranking of the user's expertise in alert handling,
associating one product user with another product user based on the user profiles; and
providing a forum for the associated product users to share information related to alert handling.

15. The method of claim 14, wherein providing a forum further comprises:
enabling the product users to communicate without sharing user identification information.

16. The method of claim 14, wherein the forum includes at least one of a message board, a chat room, and wiki collaboration.

17. A system for managing remediation of alerted products, comprising:
software components embodied on a computer-readable medium, the components comprising:
an alert distribution and management component configured to:
identify an alert related to a product;
facilitate handling of the alert by a user of the product; and
receive data related to alert handling from the product user; and
a collaboration component configured to:
analyze data related to alert handling with other data relating to the alert; and
monitor remediation efforts related to the alert based on the analyzed data; and
a display device for displaying the analyzed data.

18. The system of claim 17, wherein the collaboration component is further configured to:
identify a target user among the plurality of users of the product; and
provide a communication channel between the target user and users of the product.

19. The system of claim 17, wherein the collaboration component is further configured to:
identify a user of the product affected by the alert; and
distribute information related to the alert to the product user.

20. The system of claim 17, wherein the collaboration component is further configured to:
receive a request from a user of the product for information on handling the alert; and
provide the product user with information on handling the alert based on the analyzed data.
